(19) United States
(12) Patent Application Publication
(10) Pub. No.: US 2022/0170566 A1
(43) Pub. Date: Jun. 2, 2022

(54) VALVE

(71) Applicant: NEOPERL GmbH, Müllheim (DE)

(72) Inventor: Adrijan Strmsek, Maribor (SI)

(73) Assignee: NEOPERL GmbH, Müllheim (DE)

(21) Appl. No.: 17/599,965

(22) PCT Filed: Mar. 31, 2020
(86) PCT No.: PCT/EP2020/059095

§ 371 Date: Sep. 29, 2021

(30) Foreign Application Priority Data
Apr. 12, 2019 (DE) 20 2019 102 127.6

(51) Int. Cl. F16K 31/52; F16K 3/02; F16K 3/314; F16K 31/56; F16K 31/08

(52) U.S. Cl. CPC F16K 31/523; F16K 3/0254; F16K 31/084; F16K 31/56; F16K 3/314

(57) ABSTRACT

The disclosure relates to a valve having an inlet device, which has at least one inlet opening and at least one outlet opening, and having a closing device for opening and closing the at least one inlet opening and/or outlet opening. The valve has an actuation device for actuating the closing device. The actuation device is guided in an axially moveable manner in a first direction in a housing. The valve further has a coupling element, which connects the actuation device and the closing device to one another such that an axial movement of the actuation device causes a movement of the closing device in a second direction that differs from the first direction.

The invention relates to a valve having an inlet device, which has at least one inlet opening and at least one outlet opening, having a closing device for opening and closing the at least one inlet opening, and having an actuating device for actuating the closing device.

Valves are designed to control a fluid stream. With the valve open, the fluid passes through the inlet opening and exits the valve through the outlet opening. The closing device serves for closing the inlet opening. With the valve closed, the inlet opening is closed off by the closing device. Then, no fluid can exit the valve.

Valves are used in numerous products and applications. The invention is directed in particular at the area of sanitary engineering. Said valves may be used for example in fittings. Other application possibilities are also conceivable, for example use in household appliances, such as for example dishwashers or washing machines. Industrial applications are likewise possible. Basically, the invention can be used wherever a fluid stream has to be controlled. The fluid is in particular water or a liquid.

DE 42 38 671 A1 has disclosed a generic valve which is designed in the form of a single-lever mixer fitting. The actuating device is in the form of a lever which is mounted pivotably in a housing. In the housing, the lever engages into a closing device, which controls the water stream of a hot-water opening and of a cold-water opening. According to the direction in which the lever is pivoted, more or less water passes through the cold-water opening and the hot-water opening, with the result that the temperature at which the water exits from an outlet opening of the valve can be controlled via the degree of inclination of the lever.

A similar design is known from DE 20 2012 100 687 U1, in which use is likewise made of a pivotable lever as an actuating device.

In EP 2 971 387 B1, too, the actuating device is mounted pivotably in a valve housing. Through pivoting of the actuating device, a closing device is moved in an axial direction such that the inlet opening of the valve is closed off or opened. The known valve is used as a shut-off valve of a hand-held shower device connected via a hose to the water supply. The actuating device at the same time forms the holder for the hand-held shower device. If the hand-held shower device is in the holder, the water feed is closed. If the hand-held shower device is taken from the holder, the actuating device pivots into an open position by way of the preload of a spring. In said open position, the valve is open, and the hand-held shower device is supplied with water. Such hand-held shower devices are also referred to as shattafs.

The invention is based on the object of providing a valve with alternative actuation.

The object is achieved by a valve having the features of claim 1.

According to the invention, the actuating device is guided in a housing so as to be axially movable in a first direction. Such an axial guide of the actuating device is particularly space-saving in comparison with conventional pivotable solutions. According to the invention, there is furthermore provided a coupling element, which is coupled to the actuating device and to the closing device, wherein an axial movement of the actuating device effects a movement of the closing device in a second direction, which differs from the first direction. The actuating device therefore drives the coupling element, which, for its part, drives the closing device. The design according to the invention is compact, simply constructed and functionally reliable.

Preferably, the closing device effects opening and closing of the at least one inlet opening. Alternatively or additionally, it can also effect opening and closing of the outlet opening.

Within the context of the invention, inlet opening is to be understood as meaning an inlet channel which is formed by the inlet device. Equally, within the context of the invention, inlet opening is however also to be understood as meaning the opening in a plane which adjoins the closing device. Within the context of the invention, outlet opening is to be understood as meaning an outlet channel which is formed by the inlet device. Equally, within the context of the invention, outlet opening is however also to be understood as meaning the opening in a plane which adjoins the closing device.

The invention can be used in numerous applications, such as for example in the form of a valve for sanitary fittings or in the form of a valve for household appliances, such as for example washing machines or dishwashers. Industrial applications are also conceivable.

Another advantage of the valve according to the invention is the small dead space in which the fluid dwells when said valve is closed. The prior art has disclosed so-called pilot valves, in the case of which a diaphragm is used as a closing device and, for pressure equalization, water passes to behind the diaphragm on the flow side. Said water remains behind the diaphragm at least partially even with the valve open, and so there is the risk of contamination. By contrast, the valve according to the invention has the considerable advantage that no stagnating fluid occurs with the valve open. This is because, with the valve open, the fluid is carried along by the stream. This also results in hygienic advantages.

Preferably, an axial movement of the actuating device effects a translational movement of the closing device. The closing device is thus not rotated during its movement, but rather is mounted so as to be movable in a translational manner, preferably in one dimension, in the housing. Such a mounting is simple and has a high service life.

An advantageous embodiment of the invention is characterized in that the movement direction of the actuating device and the movement direction of the closing device are oriented orthogonally with respect to one another. In particular, it may be provided that the actuating device is guided in a first guide and the closing device is guided in a second guide, wherein the first and second guides are oriented orthogonally with respect to one another. The orthogonal arrangement of the movement directions provides a completely new kinematic concept, which permits a simple and durable design of the valve.

In one refinement of the invention, it is proposed that, when the actuating device is actuated, the closing device slides on the inlet device. The inlet device expediently forms the inlet opening and/or the outlet opening, so that these/this can be closed off in a simple manner by way of the sliding movement. Such a closure is regarded as very reliable. Furthermore, such a design is durable since, by way of the sliding movement, the sealing region is kept free of deposits, in particular free of limescale deposits.

According to the invention, the inlet device has at least one inlet opening and at least one outlet opening. Preferably, in an open position of the valve, the closing device and the inlet device form a channel which connects the at least one inlet opening and the at least one outlet opening to one another. When the valve is open, the fluid, which is preferably a liquid, can enter the channel through the inlet opening and exit from the outlet opening. In this way, the flow path through the valve can be kept very short and the design can, overall, be kept very simple. Advantageously, in a closed position of the valve, the closing device closes off the at least one inlet opening of the inlet device.

The coupling element is connected to the actuating device and to the closing device. A kinematically particularly advantageous embodiment is characterized in that the coupling element is connected pivotably to the actuating device. As soon as the actuating device is moved in the axial direction, the pivotable coupling element transports the closing device advantageously into its open position or closed position. In this way, a particularly flat structural form can be realized. This is the case in particular if the pivot axis of the coupling element is formed orthogonally with respect to the movement axis of the actuating device, as is regarded as advantageous per se. Additionally or alternatively, the coupling element may be connected pivotably to the closing device. Preferably, the pivot axis of the closing device extends parallel to the pivot axis of the actuating device. In this context, it should be pointed out that the pivot axis of the closing device need not necessarily be formed by the closing device. Rather, the closing device can also receive the coupling element in such a way that the latter is pivotable. The same applies to the actuating device.

It has already been mentioned above that it is advantageous if the closing device can slide on the inlet device. In this way, both devices are subjected to a certain loading. For minimizing wear, it is proposed that the inlet device consists of a ceramic material. In addition to its good wear properties, the ceramic material has yet further advantages. In particular, it can be produced with very high fitting accuracy. Furthermore, it is resistant to aggressive media, such as acids or the like. This permits use of the valve in a wide range of industrial applications. Additionally or alternatively, the closing device may also consist of a ceramic material. If the two components movable one on top of the other consist of a ceramic material, a highly wear-resistant material pairing is obtained. This results in a high service life of the valve.

Preferably, the closing device has a slide piece which, when the actuating device is actuated, slides on the inlet device. The slide piece preferably consists of a ceramic material having the above-described advantages. An advantage of a multi-part closing device is that each part can be adapted to its primary purpose of use. The slide piece will be formed from a wear-resistant, in particular abrasion-resistant, material, such as for example a ceramic material. A top part can be mounted onto the slide piece. Additionally or alternatively, the top part may be connected to the slide piece. The connection is preferably detachable. For example, it is a form-fitting connection.

The top part preferably does not come into contact with the fluid. It preferably consists of a different material, for example a plastic. This makes it possible for the top part to be able to be produced as an injection-molded part and thus inexpensively. Furthermore, a multi-part design of the closing device permits an advantageous assembly of the valve.

Preferably, the top part and the slide piece are in engagement with one another. Whenever the coupling element moves the closing device, the slide piece and the top part move together.

It is regarded as particularly preferable if the coupling element is mounted between the top part and the slide piece. In this way, the coupling element can be advantageously held between the top part and the slide piece. At the same time, the mounting permits a movement of the coupling element, in particular a pivoting movement of the coupling element.

An advantageous embodiment of the invention is characterized in that the valve has a linear guide in which the closing device is guided in a linearly movable manner. This ensures always correct positioning of the closing device in relation to the inlet device, which is relevant in particular for the closed position of the valve. A simple and effective linear guide may be realized in that it has at least one guide rail which interacts with at least one slide surface of the closing device. The slide surface slides on the guide rail during a movement of the closing device. In this case, the at least one slide surface bears against the guide rail. Preferably, the at least one guide rail is of straight form.

Advantageously, the linear guide has two guide rails, wherein each guide rail interacts with an associated slide surface of the closing device. For example, the guide rail forms inner surfaces which bear in each case against an outwardly directed slide surface. In this case, the linear guide may engage over the closing device.

It has already been mentioned above that it is advantageous if the valve permits a simple assembly. In this context, it is proposed that the linear guide is accommodated as a separate component in the housing, wherein preferably, between the housing and the linear guide, there are provided centering means for orienting the linear guide in the housing. The centering means may be in the form of a groove or in the form of a tongue that interact with a tongue or groove formed on the inner side of the housing. Centering of the linear guide is also advantageous to the extent that it defines the movement direction of the closing device. In this way, a high degree of reliability of the closing action and opening action of the valve can be ensured.

For the actuation of the valve, different mechanisms come into consideration. One possibility is that the actuating device remains in the closed position or open position if it has been actuated. If it is pressed for example, the valve is opened and remains in the open position until the actuating device is actuated again. Alternatively, the valve is in the open position and the actuating device, after being actuated, always returns to this open position again. In other words, if the actuating device is not held in a pressed state, it is in the starting position, in which the valve is in the open position. Such a mechanism opens up completely new application possibilities, as will be explained in more detail in conjunction with the description of the figures.

An advantageous embodiment of the invention is characterized in that the actuating device is preloaded into the open position, wherein, if the actuating device is not actuated, it is in the open position of the valve.

Such a mechanism may preferably be realized in that the linear guide forms a bearing for a preloading means which is supported on the linear guide and which preloads the actuating device into an open position of the valve. The preloading means may be a spring.

Alternatively, the actuating device has a magnet, which is preferably arranged on a free end of the actuating device. The magnet may interact with a counter magnet in such a way that the counter magnet draws the actuating device out of the housing. For example, the counter magnet is assigned to a hand-held shower device. As soon as the hand-held shower device is pulled off from the housing, the magnet and thus also the actuating device is also pulled (further) out of the housing.

In the case of generic valves, it is known that the valves have a housing. Said valves can then be used in the form of a cartridge, for example in sanitary installations such as fittings. The actuating device is preferably in the form of a button which, in an open position or in a closed position of the valve, is supported against the inner side of the housing. For this purpose, the button advantageously has a shoulder. The shoulder serves as a stop for the button, which is expediently under preload.

In one refinement of the invention, it is proposed that the housing has a housing bottom part and a housing top part, which is connected to the housing bottom part, wherein, in the housing bottom part, there are formed at least one inlet and at least one outlet, which are connected in terms of flow to the at least one inlet opening and to the at least one outlet opening of the inlet device. The fluid therefore enters the valve through the inlet into the inlet opening and exits the valve through the outlet opening and the outlet of the housing. Preferably, here, the actuating device is guided axially in the housing top part. The closing device and the coupling element are advantageously arranged in the housing. The result is a compact, universally usable cartridge.

The invention permits numerous embodiments. If the actuating device is in an actuated state, that is to say in a pressed state, the valve may be in the closed position or in the open position. The closing device may be adapted accordingly for this purpose. Embodiments in which the actuating device is pressed into its starting position by preloading means are possible. Here, said starting position may be the open position or the closed position. If the actuating device is in its pressed position and is then no longer actuated, the preloading means can press the actuating device back into its starting position. Alternatively, within the context of the invention, there are provided embodiments in which the actuating device may assume two end positions in which it remains. Here, said end positions may be the open position or the closed position of the valve. For example, it is proposed that the valve can be opened and closed according to the ballpoint pen principle. The ballpoint pen principle is known per se. In connection with the valve according to the invention, it permits the assumption of two stable end positions by the actuating device. An advantageous embodiment is characterized in that, on its inner side, the housing top part has guides for a latching element of the actuating device, and has first stops against which the actuating device bears in a first end position. In this end position, the actuating device is preferably in a state pressed into the housing counter to the preload force of the preloading means. Here, the valve may be open or closed. The formation of the guide and the stops in the housing top part results in a compact and simple design. Preferably, at end sides, the guides have second stops against which the actuating device bears in a second end position. In this end position, the actuating device is preferably in its starting position.

The invention will be explained in more detail below on the basis of preferred exemplary embodiments in conjunction with the appended drawing. In the drawing:

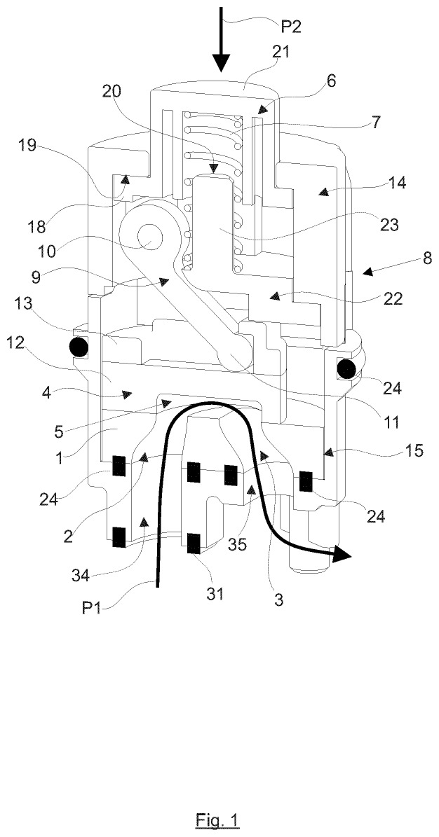

FIG. 1 shows, in a schematic illustration, a sectional view of a first exemplary embodiment of the valve according to the invention in an open position;

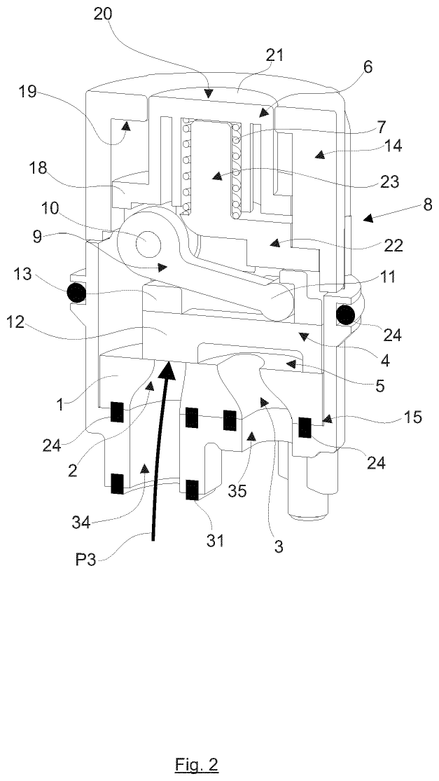

FIG. 2 shows, in a schematic illustration, a sectional view of the first exemplary embodiment in a closed position;

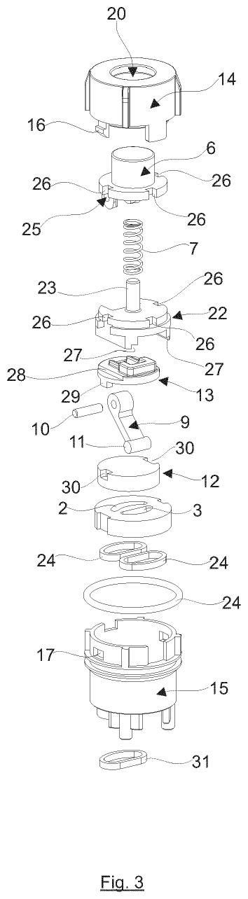

FIG. 3 shows, in a schematic illustration, an exploded view of the first exemplary embodiment;

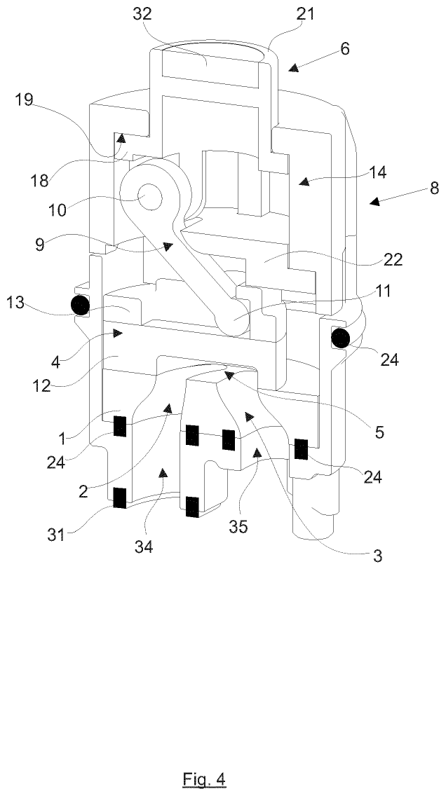

FIG. 4 shows, in a schematic illustration, a sectional view of a second exemplary embodiment according to the invention in an open position;

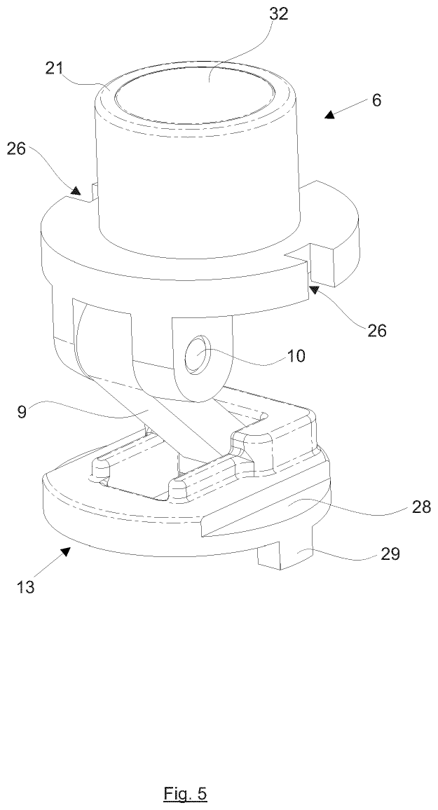

FIG. 5 shows, in a schematic illustration, a detail of the second exemplary embodiment in a perspective view obliquely from above;

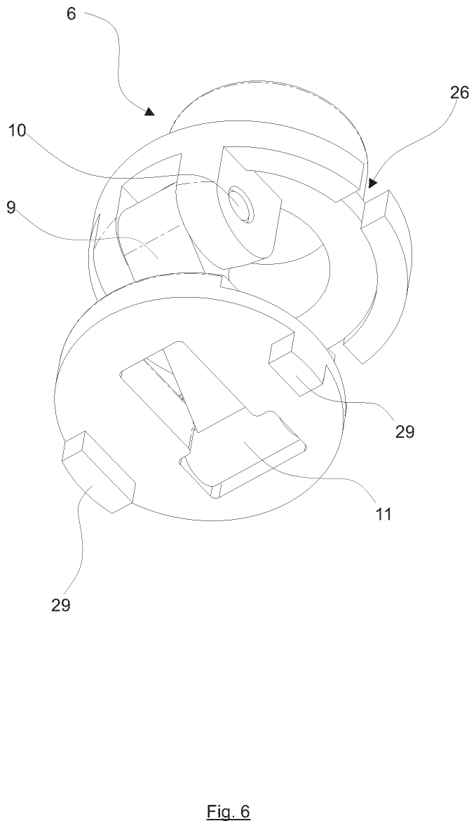

FIG. 6 shows, in a schematic illustration, the detail in FIG. 5 in a perspective view obliquely from below;

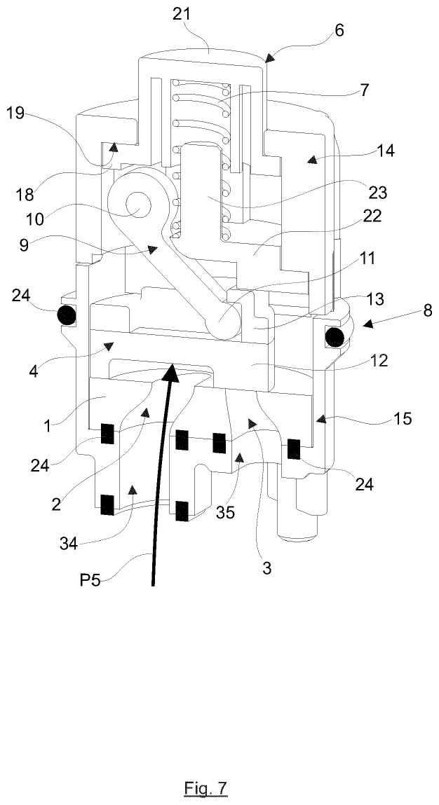

FIG. 7 shows, in a schematic illustration, a sectional view of a third exemplary embodiment of the valve according to the invention in a closed position;

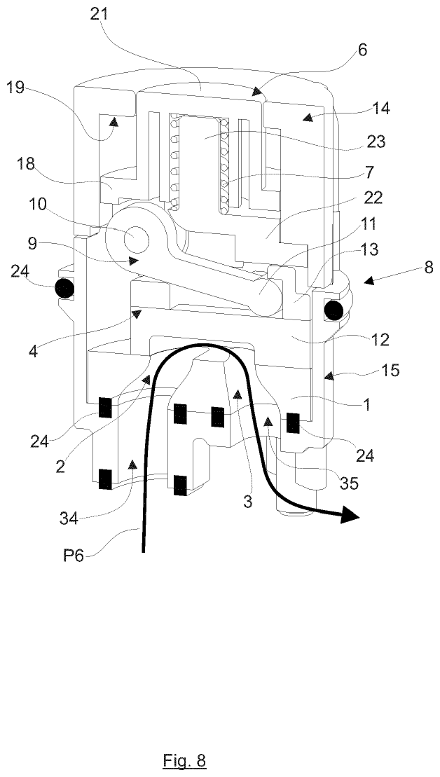

FIG. 8 shows, in a schematic illustration, a sectional view of the third exemplary embodiment in an open position;

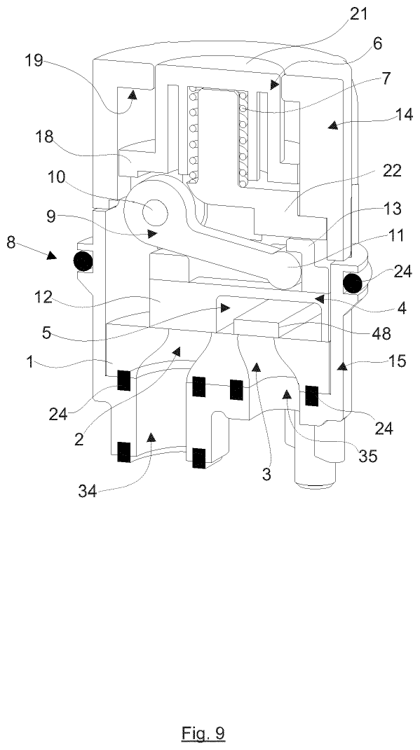

FIG. 9 shows, in a schematic illustration, a sectional view of a fourth exemplary embodiment of the valve according to the invention in a closed position;

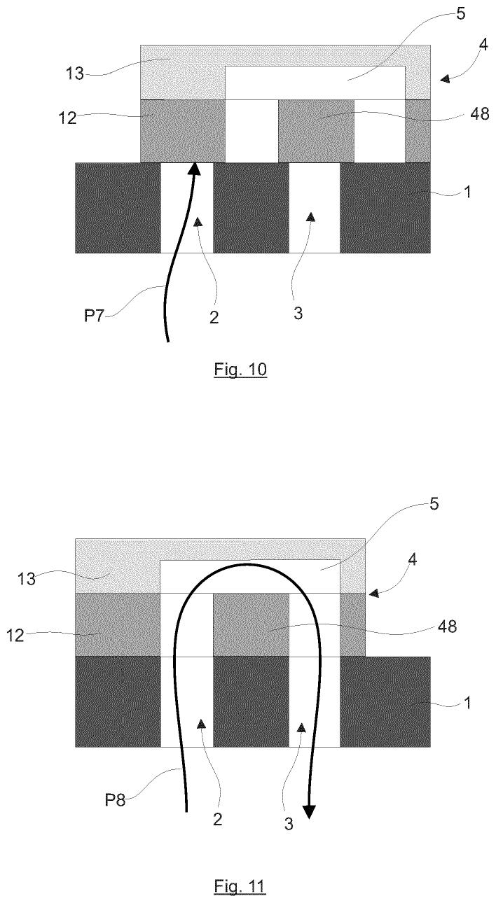

FIG. 10 shows a functional diagram of the fourth exemplary embodiment in the closed position;

FIG. 11 shows a functional diagram of the fourth exemplary embodiment in the open position;

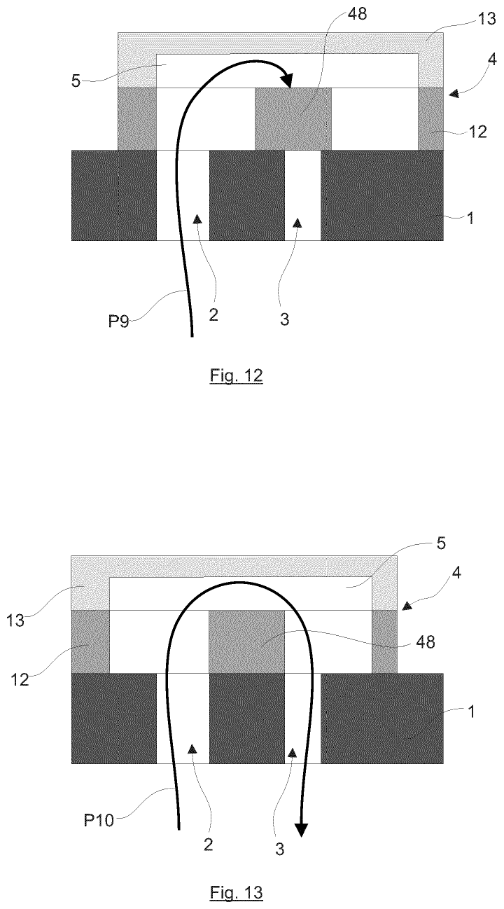

FIG. 12 shows a functional diagram of a fifth exemplary embodiment in the closed position;

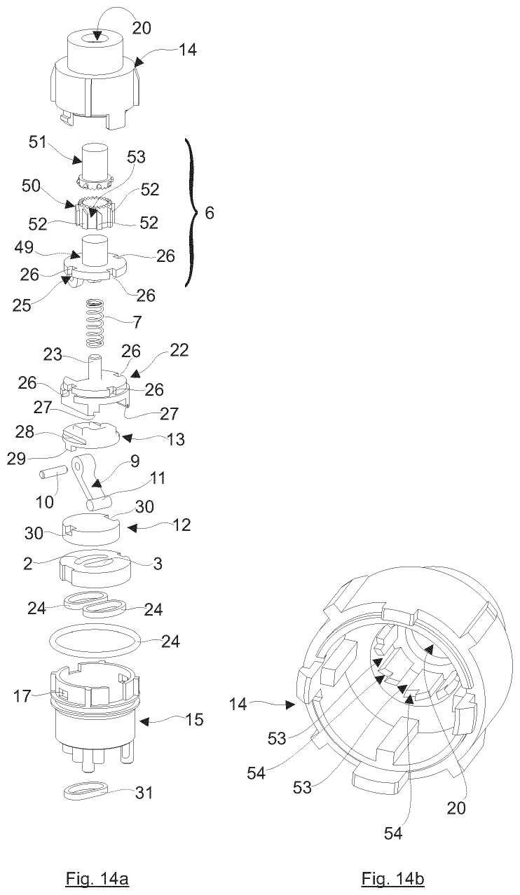

FIG. 13 shows a functional diagram of the fifth exemplary embodiment in the open position;

FIG. 14a shows, in a schematic illustration, an exploded view of a sixth exemplary embodiment;

FIG. 14b shows a detail of the sixth exemplary embodiment in an enlarged view;

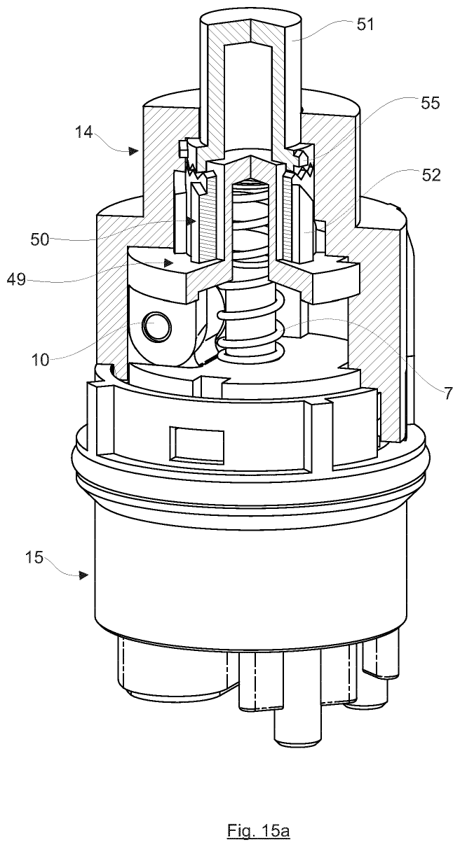

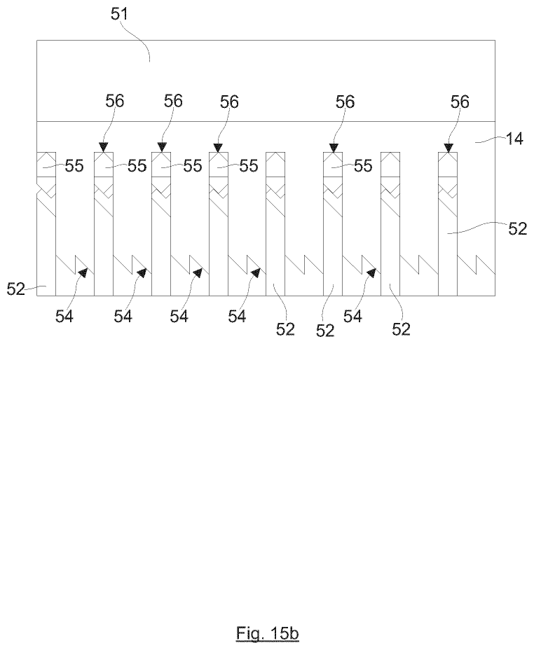

FIG. 15a shows, in a schematic illustration, a partially sectional view of the sixth exemplary embodiment in a closed position;

FIG. 15b shows a functional diagram of the sixth exemplary embodiment in relation to FIG. 15a;

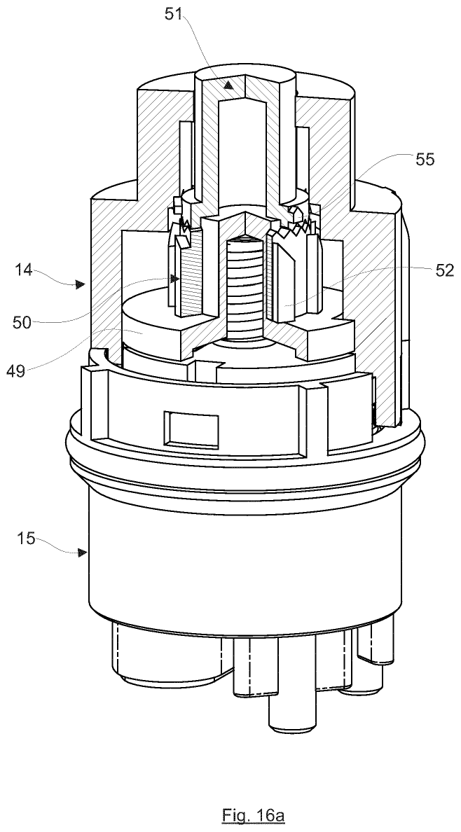

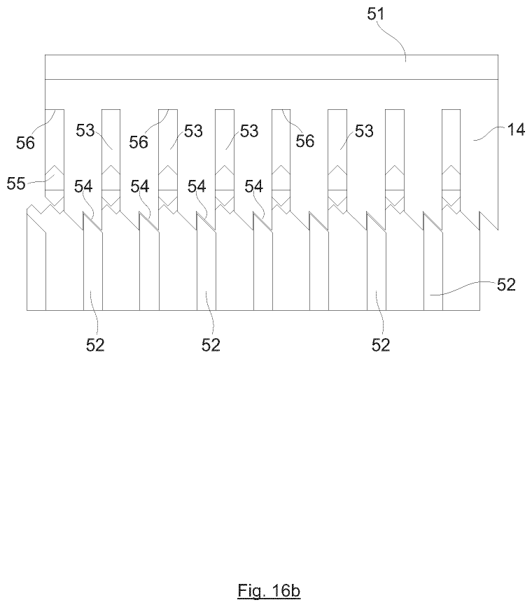

FIG. 16a shows, in a schematic illustration, a partially sectional view of the sixth exemplary embodiment in an open position;

FIG. 16b shows a functional diagram of the sixth exemplary embodiment in relation to FIG. 16a;

FIG. 17 shows, in a schematic illustration, a partially sectional view of the second exemplary embodiment in the installed state in a closed position;

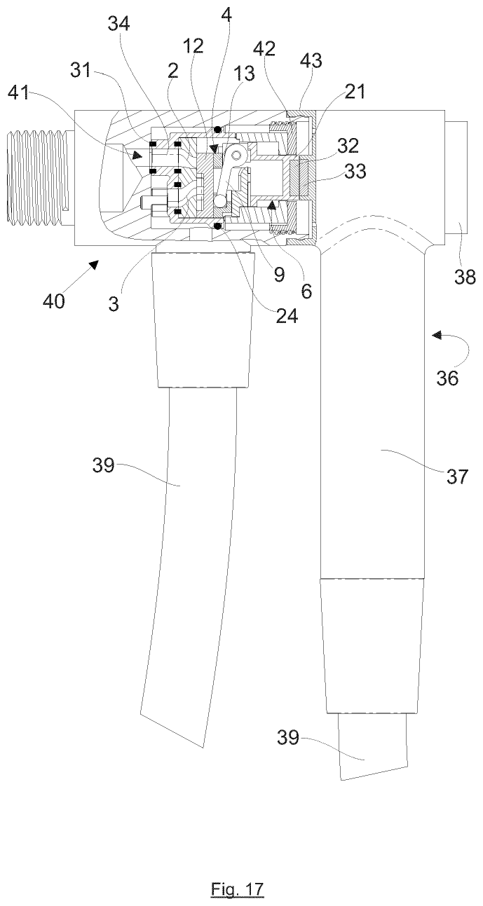

FIG. 18 shows, in a schematic illustration, a sectional view of the second exemplary embodiment in the installed state in an intermediate position;

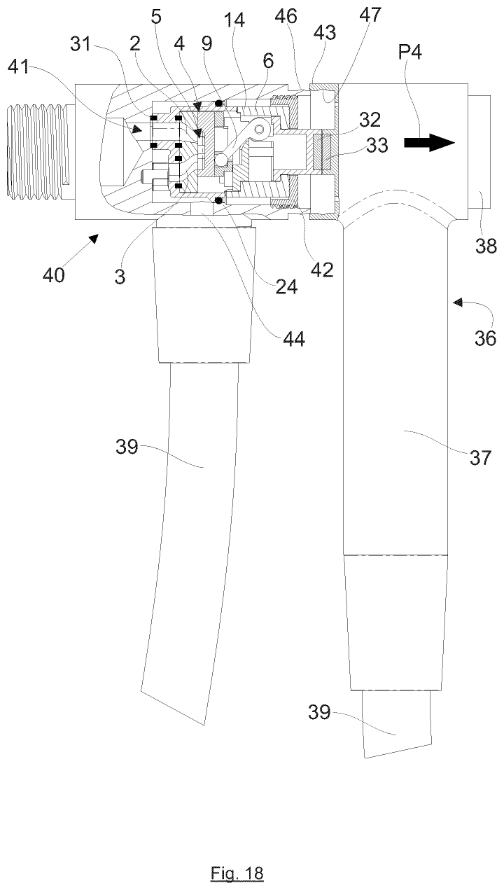

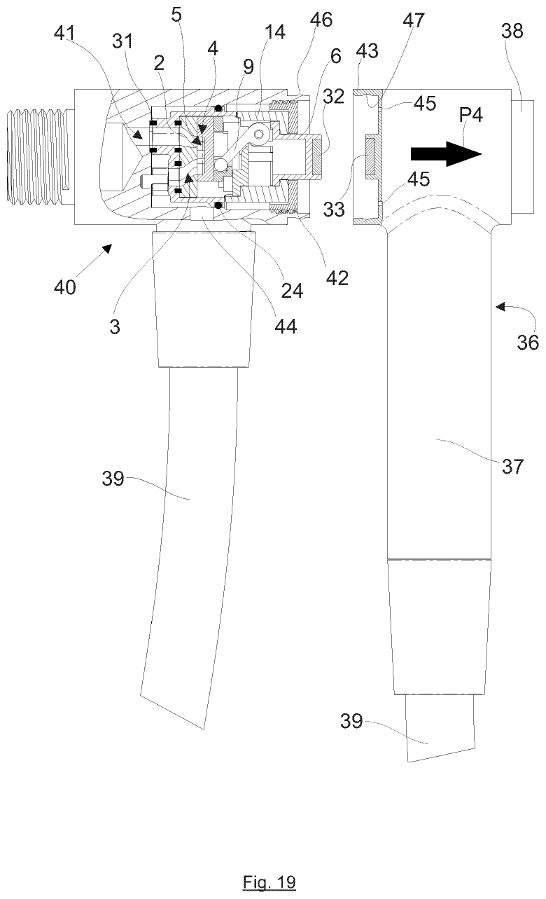

FIG. 19 shows, in a schematic illustration, a sectional view of the second exemplary embodiment in the installed state in an open position;

FIG. 20 shows, in a schematic illustration, a sectional view of a seventh exemplary embodiment of the valve according to the invention in an open position;

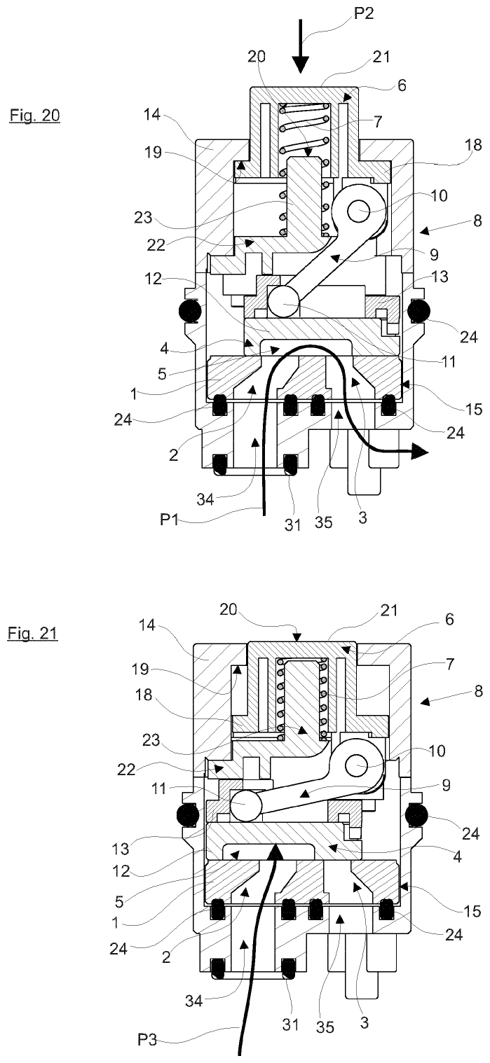

FIG. 21 shows, in a schematic illustration, a sectional view of the seventh exemplary embodiment in a closed position;

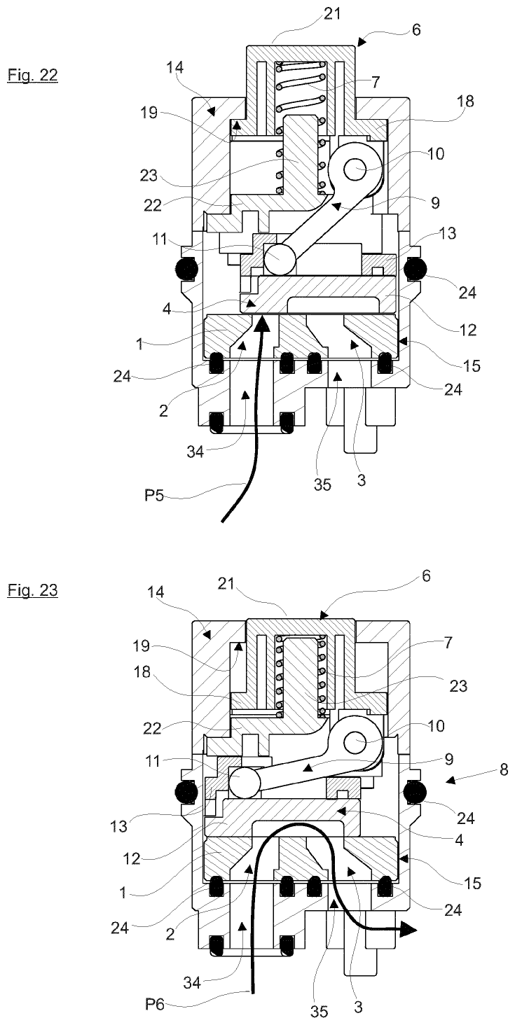

FIG. 22 shows, in a schematic illustration, a sectional view of an eighth exemplary embodiment of the valve according to the invention in a closed position; and

FIG. 23 shows, in a schematic illustration, a sectional view of the eighth exemplary embodiment in an open position.

FIG. 1 shows a first exemplary embodiment of the valve according to the invention. The valve has an inlet device 1 with an inlet opening 2 and has an outlet opening 3. Within the context of the invention, it is also possible for multiple inlet openings 2 and/or multiple outlet openings 3 to be provided. The inlet device 1 preferably consists of a ceramic material. In this way, it is resistant to aggressive media and is furthermore resistant to wear.

The inlet device 1 interacts with a closing device 4 which can slide on the inlet device 1. The closing device 4 has a channel 5 which, in the illustrated open position of the valve, connects the inlet opening 2 to the outlet opening 3. In this way, fluid, for example a liquid, in particular water, can flow through the inlet opening 2 and flow out from the outlet opening 3, as is indicated by the arrow P1. At this juncture, it should be pointed out that, in the illustrated exemplary embodiment, the closing device 4 forms the channel 5. Basically, it is advantageous for the closing device 4 and the inlet device 1 to form a channel 5 which connects the at least one inlet opening 2 and the at least one outlet opening 3 to one another.

The valve according to the invention can be actuated by means of an actuating device 6. A spring 7 holds the actuating device 6 in the open position of the valve. The actuating device 6 is guided axially displaceably in a housing 8 and can be moved in the direction of the arrow P2 counter to the preload of the spring 7.

A coupling element 9 is coupled to the actuating device 6. For this purpose, the actuating device 6 has a pivot axle 10 on which the coupling element 9 is mounted pivotably. The coupling element 9 has a free end 11, by way of which the coupling element 9 is mounted pivotably on the closing device 4.

The closing device 4 is of multi-part form in the present case and has a slide piece 12 and a top part 13, between which the free end 11 of the coupling element 9 is received in a pivotable manner. The slide piece 12 may consist of a different material than the top part 13, in particular of a ceramic material. If the inlet device 1 also consists of a ceramic material, this material pairing forms a wear-resistant and thus durable interface between the inlet device 1 and the closing device 4. The top part 13 may consist for example of plastic, since it is not loaded as intensely as the slide piece 12. Preferably, the slide piece 12 and the top part 13 are in engagement with one another, as will be explained in more detail in conjunction with FIG. 3.

The housing 8 has a housing top part 14 and a housing bottom part 15, which are in engagement with one another. For this purpose, there are arranged on the housing top part latching noses 16, which engage into corresponding cutouts 17 of the housing bottom part 15 (see FIG. 3).

The actuating device 6 is guided axially displaceably in the housing 8, in particular in the housing top part 14. As already stated above, the actuating device 6 is preloaded into its starting position—the open position of the valve. In this position, the actuating device 6 is supported by way of a shoulder 18 against an inner side 19 of the housing top part 14. Preferably, in the open position of the valve, the actuating device 6 extends through an opening 20 in the housing top part 14 and projects with its free end 21 out of the housing 8.

The reference sign 22 denotes a linear guide. This may have a number of tasks. Firstly, it ensures that the closing device 4 is guided linearly in the housing 8, as will be explained in more detail in conjunction with FIG. 3. Secondly, it can be seen in particular from FIGS. 1 and 2 that, in the illustrated exemplary embodiment, the linear guide 22 also has a spring guide 23. The latter serves for guiding and for supporting the spring 7, but preferably also for (additionally) guiding the actuating device 6. Basically, it is regarded as advantageous that the linear guide 22 is kept stationary in the housing 8.

The inlet device 1 is kept stationary in the housing bottom part 15 and is sealed off with respect to the housing bottom part 15. In particular, the inlet opening 2 and the outlet opening 3 are sealed off with respect to the housing bottom part 15 by seal rings 24.

The valve according to the invention may be designed in the form of a cartridge. It may be inserted as such into a sanitary fitting, for example. For this purpose, the housing bottom part 15 has an encircling seal ring 24 which seals off the housing 8 with respect to the fitting. The seal ring 24 may also be arranged on the housing top part 14.

FIG. 1 shows the first exemplary embodiment of the valve according to the invention in an open position of the valve.

FIG. 2 shows the first exemplary embodiment in a closed position of the valve. In the following text, reference is made to FIG. 2.

In FIG. 2, the actuating device 6 is in a state pressed counter to the force of the spring 7. In this position, the spring guide 23 forms a stop for the actuating device 6. When the actuating device 6 is moved from the open position as per FIG. 1 into the closed position as per FIG. 2, the pivot axle 10 is also moved together with the actuating device 6. In this case, the coupling element 9 is pivoted and, by way of its free end 11, moves the closing device 4 into the closed position (that is to say to the right in FIG. 2). Here, the closing device 4 slides on the inlet device 1. In the closed position, the closing device 4 closes off the inlet opening 2, as is indicated by the arrow P3. Thus, in the closed position, the fluid can no longer enter the inlet opening 2. In the closed position, the valve is closed.

At this juncture, it should be pointed out that the first exemplary embodiment is constructed in such a way that the valve is closed for as long as the actuating device is held in the closed position. If force is no longer exerted on the actuating device 6, the actuating device 6 moves into the open position on account of the preloading by the spring force. In the open position, the valve is open (cf. FIG. 1).

FIG. 3 shows an exploded view of the first exemplary embodiment. It has already been explained above that the housing top part 14 preferably has latching noses 16 which can engage into cutouts 17 of the housing bottom part 15. Preferably, the housing top part 14 and the housing bottom part 15 are connected detachably to one another.

The actuating device 6 has two receiving means 25, through which the pivot axle 10 is plugged. The coupling element 9 is mounted pivotably on the pivot axle 10.

Within the context of the concept of the invention, it is regarded as advantageous if the actuating device 6 is guided axially in the housing 8 and the closing device 4 advantageously performs, during the movement of the actuating device 6, a translational, one-dimensional movement. In order that all the components are oriented correctly in relation to one another, the actuating device 6 and/or the linear guide 22 preferably have/has centering means, which may be in the form of grooves 26, as is illustrated in FIG. 3. This ensures correct positioning of the actuating device 6 and the linear guide 22 in the housing 8 and thus correct orientation of the movement direction of the closing device 4.

Preferably, the linear guide 22 forms a linear guide for the closing device 4. For this purpose, the linear guide 22 advantageously has at least one guide rail 27, preferably two guide rails 27, which interact with corresponding slide surfaces 28 of the closing device 4. In the present case, the linear guide 22 advantageously engages over the closing device 4. In the first exemplary embodiment, the slide surfaces 28 are formed on the top part 13 of the closing device. The top part 13 engages with at least one projection 29 into grooves 30 of the slide piece 12. The guidance of the closing device 4 in the linear guide 22 ensures that, when the actuating device 6 is actuated, the slide piece 12 performs a defined movement, which is advantageously a linear movement. This ensures that the closing device 4, in an open position, connects the inlet opening 2 to the outlet opening 3 and, in the closed position, closes off the inlet opening 2.

The reference sign 31 denotes a seal which seals off the valve according to the invention with respect to a fitting body, as will be explained in more detail in conjunction with FIGS. 7 to 9.

FIG. 4 shows a second exemplary embodiment of the valve according to the invention. At this juncture, it should be noted that, in the present figure description, similar components of the valve according to the invention, for reasons of clarity, are, in part, denoted by the same reference signs, even if they have a slightly different construction.

By contrast to the first exemplary embodiment, the second exemplary embodiment has no spring. The return force for returning the actuating device 6 is provided by a magnet 32 which is arranged on the free end 21 of the actuating device. The fact that no spring is required means that, at the linear guide 22, the spring guide 23 is dispensed with too. Otherwise, the second exemplary embodiment is formed substantially identically to the first exemplary embodiment.

Analogously to FIG. 1, the second exemplary embodiment is shown in an open position. In said position, the free end 21 of the actuating device 6 projects out of the housing 8. As soon as the actuating device 6 is moved into the housing 8, the coupling element 9 converts the axial movement of the actuating device 6 into a lateral movement of the closing device 4. Advantageously, the movement direction of the actuating device 6 and the movement direction of the closing device 4 are oriented orthogonally with respect to one another.

In order for the valve according to the second exemplary embodiment to be transferred from the closed position analogous to FIG. 2 into an open position, the magnet 32 is drawn out of the housing 8 by means of a second magnet 33 (see FIG. 7), as will be explained in more detail in conjunction with FIGS. 7 to 9.

Furthermore—as with the first exemplary embodiment—there are formed in the housing bottom part 15 an inlet 34 and an outlet 35, which are connected in terms of flow to the inlet opening 2 and the outlet opening 3.

In the following text, reference is made to FIGS. 5 and 6, which show a detail of the second exemplary embodiment, specifically the coupling of the actuating device 6 to the closing device 4 via the coupling element 9, wherein, in the present case, only the top part 13 of the closing device 4 is illustrated.

The actuating device 6 has a pivot axle 10 on which the coupling element 9 is mounted pivotably. The coupling element 9 is, with its other end 11, in engagement with the closing device 4 (see FIG. 4). An axial movement of the actuating device 6 results in a lateral movement of the closing device 4. As becomes clear from FIGS. 5 and 6, the coupling element 9 is received between the top part 13 and the slide piece 12 of the closing device 4. In particular, the coupling element is mounted pivotably between the top part 13 and the slide piece 12.

FIGS. 5 and 6 illustrate a detail of the second exemplary embodiment in which a magnet 32 is arranged in the actuating device 6. The functioning principle corresponds (without magnet 32) to the first exemplary embodiment.

In the following text, reference is made to FIGS. 7 and 8, which show a third exemplary embodiment of the invention. The third exemplary embodiment differs from the first and second exemplary embodiments in that the valve is in its closed position with a non-pressed actuating device 6. In the closed position, the actuating device 6 is preferably preloaded into its starting position by the spring 7. In the closed position as per FIG. 7, the closing device 4 closes off the outlet opening 3. The channel 5 is arranged above the inlet opening 2 in such a way that no fluid can flow through the inlet opening 2, as is indicated by the arrow P5.

In FIG. 8, the actuating device 6 is in a pressed state and the valve is in the open position. In the open position, the closing device 4 is arranged in relation to the inlet device 1 in such a way that the channel 5 connects the inlet opening 2 to the outlet opening 3. In this way, the fluid can flow through the inlet opening 2 and the outlet opening 3, as is indicated by the arrow P6.

Otherwise, the third exemplary embodiment corresponds to the first exemplary embodiment, to the description of which reference is hereby made.

FIG. 9 shows a fourth exemplary embodiment of the valve according to the invention. The valve is in the closed position in FIG. 9. In this case, the inlet opening 2 is closed off by the closing device 4. By contrast to the preceding exemplary embodiments, the closing device 4 has furthermore a web 48 which covers the outlet opening 3. Thus, in the closed position, the inlet opening 2 and the outlet opening 3 are closed. With regard to the remaining construction of the valve, reference is made to the first exemplary embodiment.

FIGS. 10 and 11 illustrate the position of the closing device 4 in relation to the inlet device 1 in the fourth exemplary embodiment in a functional diagram. In each case, only the closing device 4, having the slide piece 12 and the top part 13 in the present case, and the inlet device 1 are illustrated. FIG. 10 shows the fourth exemplary embodiment in the closed position, as is illustrated in FIG. 9. Here, the closing device 4 closes off both the inlet opening 2 and, by means of the web 48, the outlet opening 3. The fluid cannot enter the inlet opening 2, as is illustrated by the arrow P7. FIG. 11 shows the open position of the valve, in which open position the channel 5 connects the inlet opening 2 and the outlet opening 3 to one another, as is indicated by the arrow P8.

FIGS. 12 and 13 show a further exemplary embodiment. As per FIG. 12, in the closed position, the outlet opening 3 is closed by the closing device 4, as is illustrated by the arrow P9. In FIG. 13, the closing device 4 is in a left-hand end position, in which the channel 5 connects the inlet opening 2 to the outlet opening 3 such that the fluid can flow through the inlet opening 2, through the channel 5 and out of the outlet opening 3 (arrow P10).

In the following text, reference is made to FIGS. 14 to 16, which show a sixth exemplary embodiment of the valve according to the invention. In this exemplary embodiment, the actuating device 6 assumes two stable end positions, specifically an open position and a closed position. In the first end position, the actuating device 6 is in a state pressed into the housing top part 14 (FIG. 16) and remains there, and in the second end position, the actuating device 6 is in the starting position, in which it remains (FIG. 15).

In the description, for reasons of better clarity, reference signs are also used for slightly different components.

The sixth exemplary embodiment is based on the ballpoint pen principle, which is known per se. By pressing the actuating device 6 once, the actuating device 6 passes from the position shown in FIG. 15a into the position as per FIG. 16a. By pressing it again, the actuating device 6 passes back into the position illustrated in FIG. 15a again.

The construction of the valve as per FIG. 14 corresponds largely to the first exemplary embodiment. In this respect, reference is made to the description in particular for FIG. 3, which likewise shows an exploded illustration of the valve. Unlike the first exemplary embodiment, the actuating device 6 is of three-part form. It has a base element 49, a latching element 50 and a button 51. The latching element 50 and the button 51 are received rotatably on the base element 49. In the mounted state, the button 51 extends through the opening 20 of the housing top part 14.

The latching element 50 has along its circumference axial rails 52 which can engage into corresponding guides 53 of the housing top part 14. On the inner side of the housing top part 14, there are furthermore formed stops 54 against which the rails 52 of the latching element 50 bear in a first end position.

Reference is made to FIGS. 15a and 15b. While FIG. 15a shows a partially cut-away view of the sixth exemplary embodiment in FIG. 14, FIG. 15b illustrates a developed view of the latching element 50, of the button 51 and of the housing top part 14. The actuating device 6 or the button 51 thereof is in a second position, the starting position. In this position, the latching element 50 bears with protuberances 55 against stops 56 of the housing top part 14. The stops 56 are preferably arranged at end sides of the guides 53.

When the button 51 is pressed into the housing top part 14, the latching element 50 is moved along the guides 53 until the rails 52 pass out of the guides 53. When the button 51 is released, the rails 52 pass, for abutment, to the stops 54 (first end position), as is shown in FIGS. 16a and 16b. When the button 51 is pressed again, the rails 52 again pass into the guides 53 as far as the position as per FIGS. 15a and 15b.

Accordingly, the sixth exemplary embodiment provides a valve with two stable end positions, wherein, in one end position, the valve is in a closed position and, in the other end position, the valve is in an open position. Whether a closed position or an open position is present depends on the configuration of the closing device 4.

FIGS. 17 to 19 show an exemplary application of the valve according to the invention. Both the first and the second exemplary embodiment can be used here. The second exemplary embodiment is illustrated. A shattaf is illustrated. Other sanitary and non-sanitary fittings are also conceivable. The invention can be used wherever a fluid stream is intended to be controlled through pressing of an actuating device.

The valve according to the invention is inserted into a shattaf fitting set. The fitting set has a hand-held shower device 36 with a handle 37 and an actuating button 38. The hand-held shower device is connected to a fitting housing 40 via a hose 39. The valve is inserted into the fitting housing 40. The fitting housing 40 has a water inflow 41 which is connected in terms of flow to the inlet 34 of the valve. Here, the seals 31 seal off the housing 8 with respect to the fitting housing 40. The same applies to the seal ring 24.

The housing 8 is inserted into the fitting housing 40 and is secured in the fitting housing 40 by means of a union nut 42. The actuating device 6 can extend with its free end 21 through the union nut 42.

In FIG. 17, the valve is in the closed position. In the closed position, the inlet opening 2 is closed off by the closing device 4. The hose 39 is then not pressurized. The hand-held shower device 36 engages over the fitting housing 40 by way of a skirt 43, which holds the hand-held shower device 36 on the fitting housing 40.

As soon as the hand-held shower device 36 is pulled off from the fitting housing 40 in the direction of the arrow P4, as is illustrated in FIG. 18, the second magnet 33 brings with it the magnet 32 of the actuating device 6 and pulls said magnet out of the housing top part 14. The closing device 4 travels from the closed position into an open position, in which the channel 5 connects the inlet opening 2 to the outlet opening 3. The hose 39, in the open position, is supplied with water via a water outflow 44, so that the hand-held shower device 36 can be actuated via the actuating button 38.

In FIG. 18, the hand-held shower device 36 and the fitting are still coupled via the magnets 32 and 33. In the open position, the hand-held shower device 36 can be pulled off, as is illustrated in FIG. 19. In this position, the full water pressure prevails at the hose 39. When the actuating button 38 is actuated, water exits from the openings 45. If the hand-held shower device 36 is plugged onto the fitting housing 40 counter to the movement direction of the arrow P4, the valve is closed to preserve the hose 39. Consequently, the valve according to the invention can be used in such a way that it closes when the hand-held shower device 36 is mounted onto the fitting housing 40 and opens when the hand-held shower device is pulled off from the fitting housing 40. The reference sign 46 denotes a preferably encircling bead which interacts with a recess 47 of the hand-held shower device 36. If the hand-held shower device 36 is plugged onto the fitting housing 40, the bead 46 latches into the recess 47 such that the hand-held shower device 36 is held on the fitting housing 40.

FIGS. 20 and 21 show a seventh exemplary embodiment. The seventh exemplary embodiment is largely structurally identical to the first exemplary embodiment, so that, in this respect, the same reference signs are used, and reference is made in full to the description of the first exemplary embodiment, even if the individual components differ from one another slightly.

FIG. 20 shows the seventh exemplary embodiment in an open position and corresponds in this respect to FIG. 1. The main difference from the first exemplary embodiment is that, in the first exemplary embodiment, the closing device 4 moves to the right when the actuating device 6 is pressed (see FIG. 2). Thus, in the first exemplary embodiment, the closing device 4 is in a left-hand starting position in the open position (FIG. 1). By contrast, the closing device 4 in the seventh exemplary embodiment is in a right-hand starting position in the open position (FIG. 20). If the actuating device 6 is pressed, the closing device 4 travels to the left into the closed position (FIG. 21). Therefore, in the seventh exemplary embodiment, the closing direction functions the other way round than in the first exemplary embodiment.

FIGS. 22 and 23 show an eighth exemplary embodiment. The eighth exemplary embodiment is largely structurally identical to the third exemplary embodiment, so that, in this respect, the same reference signs are used, and reference is made in full to the description of the third exemplary embodiment, even if the individual components differ from one another slightly.

FIG. 22 shows the eighth exemplary embodiment in a closed position and corresponds in this respect to FIG. 7. Here, too, no fluid can flow through the inlet opening 2. The actuating device 6 is in a starting position. The main difference from the third exemplary embodiment is that, in the third exemplary embodiment, the closing device 4 moves to the right when the actuating device 6 is pressed (see FIG. 8). Thus, in the third exemplary embodiment, the closing device 4 is in a left-hand starting position in the closed position (FIG. 7). By contrast, the closing device 4 in the eighth exemplary embodiment is in a right-hand starting position in the closed position (FIG. 22). If the actuating device 6 is pressed, the closing device 4 travels to the left into the open position (FIG. 23). Therefore, in the eighth exemplary embodiment, the closing direction functions the other way round than in the third exemplary embodiment.

Where use is made in the present description of terms pertaining to position or direction, such as axial, lateral, above or below, said terms relate to an upright valve in which the actuating device 6 projects upward. The axis then extends from the top downward.

### LIST OF REFERENCE SIGNS

1 Inlet device
2 Inlet opening
3 Outlet opening
4 Closing device
5 Channel
6 Actuating device
7 Spring
8 Housing
9 Coupling element
10 Pivot axle
11 Free end
12 Slide piece
13 Top part
14 Housing top part
15 Housing bottom part
16 Latching nose
17 Cutout
18 Shoulder
19 Inner side
20 Opening
21 Free end
22 Linear guide
23 Spring guide
24 Seal ring
25 Receiving means
26 Groove
27 Guide rail
28 Slide surface
29 Projection
30 Groove
31 Seal
32 Magnet
33 Magnet
34 Inlet
35 Outlet
36 Hand-held shower device
37 Handle
38 Actuating button
39 Hose
40 Fitting housing
41 Water inflow
42 Union nut
43 Skirt
44 Water outflow
45 Opening
46 Bead
47 Recess
48 Web
49 Base element
50 Latching element
51 Button
52 Rails
53 Guides
54 Stop
55 Protuberance
56 Stop
P1 Arrow
P2 Arrow
P3 Arrow
P4 Arrow
P5 Arrow
P6 Arrow
P7 Arrow
P8 Arrow
P9 Arrow
P10 Arrow

1. A valve having
an inlet device, which has at least one inlet opening and at least one outlet opening,
a closing device for opening and closing the at least one inlet opening and/or the outlet opening,
an actuating device for actuating the closing device, wherein the actuating device is guided in a housing so as to be axially movable in a first direction, and
a coupling element, which connects the actuating device and the closing device to one another in such a way that an axial movement of the actuating device effects a movement of the closing device in a second direction, which differs from the first direction.

2. The valve as claimed in claim 1, wherein the closing device is mounted so as to be movable in a translational manner in the housing.

3. The valve as claimed in claim 1, wherein the movement direction of the actuating device and the movement direction of the closing device are oriented orthogonally with respect to one another.

4. The valve as claimed in claim 1, wherein, when the actuating device is actuated, the closing device slides on the inlet device.

5. The valve as claimed in claim 1, wherein, in an open position of the valve, the closing device and the inlet device form a channel which connects the at least one inlet opening and the at least one outlet opening to one another, wherein preferably, in a closed position of the valve, the closing device closes off the at least one inlet opening and/or the at least one outlet opening of the inlet device.

6. The valve as claimed in claim 1, wherein the coupling element is connected pivotably to the actuating device.

7. The valve as claimed in claim 1, wherein the coupling element is connected pivotably to the closing device.

8. The valve as claimed in claim 1, wherein the inlet device consists of a ceramic material.

9. The valve as claimed in claim 1, wherein the closing device consists of a ceramic material.

10. The valve as claimed in claim 1, wherein the closing device has a slide piece which, when the actuating device is actuated, slides on the inlet device.

11. The valve as claimed in claim 10, wherein the slide piece consists of a ceramic material.

12. The valve as claimed in claim 10, wherein the closing device has a top part which is connected to the slide piece and/or which bears on the slide piece, wherein preferably the top part consists of a different material than the slide piece.

13. The valve as claimed in claim 12, wherein the coupling element is mounted between the top part and the slide piece.

14. The valve as claimed in claim 1, wherein the valve has a linear guide in which the closing device is guided in a linearly movable manner.

15. The valve as claimed in claim 14, wherein the linear guide has at least one guide rail which interacts with at least one slide surface of the closing device, in particular bears against at least one slide surface of the closing device.

16. The valve as claimed in claim 14, wherein the linear guide is accommodated as a separate component in the housing, wherein preferably, between the housing and the linear guide, there are provided centering means for orienting the linear guide in the housing.

17. The valve as claimed in claim 14, wherein the linear guide forms a bearing for a preloading means, in particular for a spring, which is supported on the linear guide and which preloads the actuating device into an open position of the valve.

18. The valve as claimed in claim 1, wherein the actuating device is in the form of a button which, in an open position or in a closed position of the valve, is supported against the inner side of the housing.

19. The valve as claimed in claim 1, wherein the actuating device has a magnet, which is preferably arranged on a free end of the actuating device.

20. The valve as claimed in claim 1, wherein the housing has a housing bottom part and a housing top part, which is connected to the housing bottom part, wherein, in the housing bottom part, there are formed at least one inlet and at least one outlet, which are connected in terms of flow to the at least one inlet opening and to the at least one outlet opening of the inlet device, and in that preferably the actuating device is guided axially in the housing top part.

21. The valve as claimed in claim 20, wherein, on its inner side, the housing top part has guides for a latching element of the actuating device, and has first stops against which the actuating device bears in a first end position.

22. The valve as claimed in claim 21, wherein, at end sides, the guides have second stops against which the latching element of the actuating device bears in a second end position.

23. A fitting, in particular a sanitary fitting, having a valve as claimed in claim 1.
